(19) United States
(12) Patent Application Publication
(10) Pub. No.: US 2007/0063999 A1
(43) Pub. Date: Mar. 22, 2007

(54) Systems and methods for providing an online lobby

(75) Inventor: Sung Pa Park, Fremont, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Hyperpia, Inc.

(21) Appl. No.: 11/233,867

(22) Filed: Sep. 22, 2005

(51) Int. Cl. G06T 15/00

(52) U.S. Cl. 345/419

(57) ABSTRACT

The invention is generally directed to online portals, and more particularly to systems and methods for providing an online lobby. In one embodiment, an online portal having a plurality of end users is accessible by a client software to be installed on an end user's workstation. The client software includes a service framework configured to generate and display a three-dimensional graphical lobby accessible by the plurality of end users and a plurality of graphical avatars located within the lobby, wherein each avatar is controlled by at least one of the plurality of end users, and wherein an end user is capable of viewing graphical avatars controlled by other end users. The online portal further includes a service rendering unit module configured to provide one or more services to the service framework available for selection by the plurality of end users; and a lobby module configured to provide lobby and avatar data to the service framework and configured to display the one or more services available for selection by the plurality of end users.

### FIELD OF THE INVENTION

The field of the invention relates to online portals, and more particularly to systems and methods for providing an online lobby.

### BACKGROUND OF THE INVENTION

Online communities have become significant contributors to the entertainment industry and increasing broadband capabilities are driving the growth. Many of the online communities are organized by special interests, such as hobbies and games. One significant type of online community is the Massive Multiplayer Online Game (“MMOG”), which is a type of computer game that enables hundreds or thousands of players to simultaneously interact in a game world they are connected to, typically via the Internet. Typically, this kind of game is played in an online, multiplayer only persistent world. This means that the game continues to play regardless of whether or not anyone else is.

An MMOG typically provides a three-dimensional virtual reality, and players interact within this virtual reality through avatars. The avatars generally have associated characteristics, such as “strength,” which indicate the type of advantages that one avatar may have over other avatars. For example, if a first avatar has a strength larger than a second avatar, the first avatar may be able to hinder or eliminate the second avatar from the game. Advantages may be gained for an avatar by completing tasks and by general continued participation in the MMOG. Thus, in order to succeed in an MMOG, heavy usage is required, and thus discouraging casual online players from participating. Furthermore, in an MMOG, there is only one general game that every player must play.

Another type of online community is the chat room, which is a place or page in a Web site or online service where people can “chat” with each other by typing messages that are displayed almost instantly on the screens of others who have access to the chat room. These types of communities allow online participants to communicate and meet one another. However, they are typically text based and not visually enticing.

In some cases, an alternative online system would be desirable.

### SUMMARY OF THE INVENTION

The invention is generally directed to online portals, and more particularly to systems and methods for providing an online lobby. In one embodiment, an online portal having a plurality of end users is accessible by a client software to be installed on an end user's workstation.

The client software includes a service framework configured to generate and display a three-dimensional graphical lobby accessible by the plurality of end users and a plurality of graphical avatars located within the lobby, wherein each avatar is controlled by at least one of the plurality of end users, and wherein an end user is capable of viewing graphical avatars controlled by other end users. The online portal further includes a service rendering unit module configured to provide one or more services to the service framework available for selection by the plurality of end users; and a lobby module configured to provide lobby and avatar data to the service framework and configured to display the one or more services available for selection by the plurality of end users.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the present inventions are obtained, a more particular description of the invention briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1a is a diagram of a graphical lobby in accordance with a preferred embodiment of the present invention;

FIG. 1b is a diagram of another graphical lobby in accordance with a preferred embodiment of the present invention;

FIG. 2 is a diagram of a computer system in accordance with a preferred embodiment of the present invention;

FIG. 3 is a diagram of another computer system in accordance with a preferred embodiment of the present invention;

FIG. 4 is a diagram of another computer system in accordance with a preferred embodiment of the present invention;

FIG. 5 is a diagram of another computer system in accordance with a preferred embodiment of the present invention;

FIG. 6 is a diagram of a server system in accordance with a preferred embodiment of the present invention;

FIG. 7 is a diagram of a filter process in accordance with a preferred embodiment of the present invention.

FIG. 8 is a diagram of a search process in accordance with a preferred embodiment of the present invention.

### DETAILED DESCRIPTION OF THE PREFERRED EMBODIMENTS

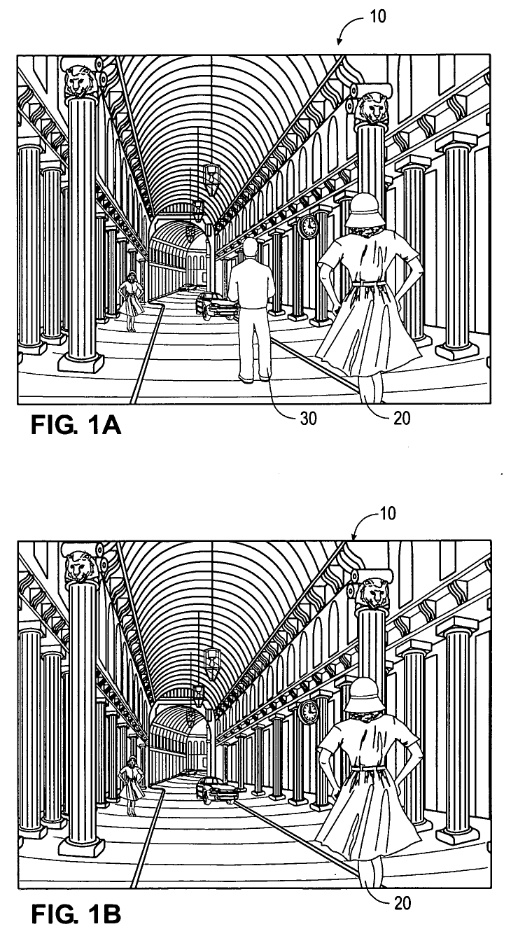

In one embodiment, an online portal is provided to a plurality of online users. Turning to FIG. 1a, the online portal includes a three-dimensional lobby 10, and an online user is provided a graphical avatar 20 to travel throughout the lobby 10. An end user may also be able to view and interact with avatars 30 controlled by other users accessing the lobby 10. However, each avatar has an associated profile, and if a particular user does not wish to view or interact with one or more avatars 30 having one or more particular profiles, then the online portal may filter out the one or more avatars 30 from the particular user's view, as shown in FIG. 1b. For example, one element in an avatar's 30 profile may be a feedback score, and if a particular end user does not want to view, or be viewed, by avatars 30 having lower than a particular feedback score, then such avatars 30 may be filtered from view, and the user's avatar 20 may be filtered from such avatars' 30 view. A profile may include any number of elements, e.g., gender, length of participation, feedback score, comments, description, etc.

The lobby 10 may be configured to depict imaginary environments and/or real life environments. For example, the lobby 10 shown in FIG. 1a represents a street in London. Other lobbies 10 may show various cities and include layouts that closely resemble the maps of the various cities. An online portal may include a large number of these lobbies 10 and allow a user to access any number of these lobbies 10.

In addition to viewing and interacting with other avatars 20, the lobby 10 also provides a number of services, such as games, for the user. Such services may be represented as one or more graphical images within the lobby 10, allowing a user to approach the one or more images and engage the service via the user's avatar 20. Such services may be independent, i.e., not part of a single game, and may include card games, sports games, first person shooting games, online shopping, and travel reservation services.

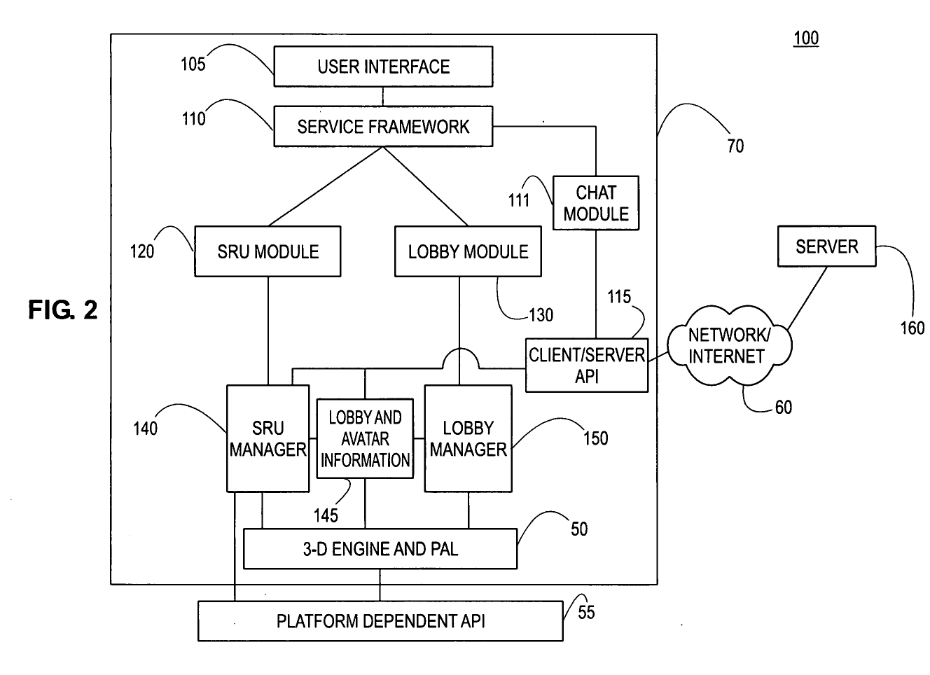

Turning to FIG. 2, a system 100 that provides such a lobby 10 and services is shown. The system 100 includes a client software program 70 downloadable to a user's workstation (not shown) from a server. The client software program 70 includes a service framework 110 that generates a user interface 105 for the lobby 10 and selected services. The service framework 110 generates the user interface 105 based on data provided by at least two software components, a service rendering unit (“SRU”) module 120 and a lobby module 130. The service framework 110 can be in the form of a graphical user interface framework known in the art, such as a Microsoft Windows framework and/or a dynamic Web page. The lobby module 130 is a software component that provides the service framework 110 with data to generate the three-dimensional lobby 10, the user's avatar 20, and any unfiltered avatars 30 controlled by other users. Data from the lobby module 130 is provided by the lobby manager 150. Information about which lobby 10 the user is accessing, the avatar 20 the user is controlling, and other avatars 30 accessing the lobby 10 are retrieved from a server 160 located remotely and accessible by a network 60, such as the Internet, via a client/server application program interface (“API”) 115. In an alternative embodiment, the API 115 may reside on the server 160. The lobby 10 and avatar 20/30 information 145 are stored by the software program 70 to be accessed by the various components. The client software program 70 further includes a chat module 111 that allows a user to engage in a real-time online chat session with another user of the portal. The chat module 111 preferably presents the chat session to the user via the service framework 110 and is coupled to the client/server API 115 to send and receive real-time data to and from the server 160.

The SRU module 120 is a software component that provides the service selected by the user to the service framework 110. The SRU is the virtual machine that executes the service, and data from the SRU is provided by an SRU manager 140 for access by the SRU module 120. In some situations, it may be desirable for particular services to have a look and feel based on the lobby 10 that the user is accessing and the type of avatar 20 representing the user. For such situations, the SRU manager 150 may access the lobby 10 and avatar 20/30 avatar information 145 to determine the look and feel. For example, if the service is an online golf game, the service may access the information 145 to determine that the user is accessing a lobby 10 representing a place in Pebble Beach, Calif. In that case, the online golf game will provide a course representing the golf course at Pebble Beach Resorts. In some situations, a particular service may only be available in certain lobbies 10. For example, a Mahjong game may only be available in a lobby 10 representing a city in China.

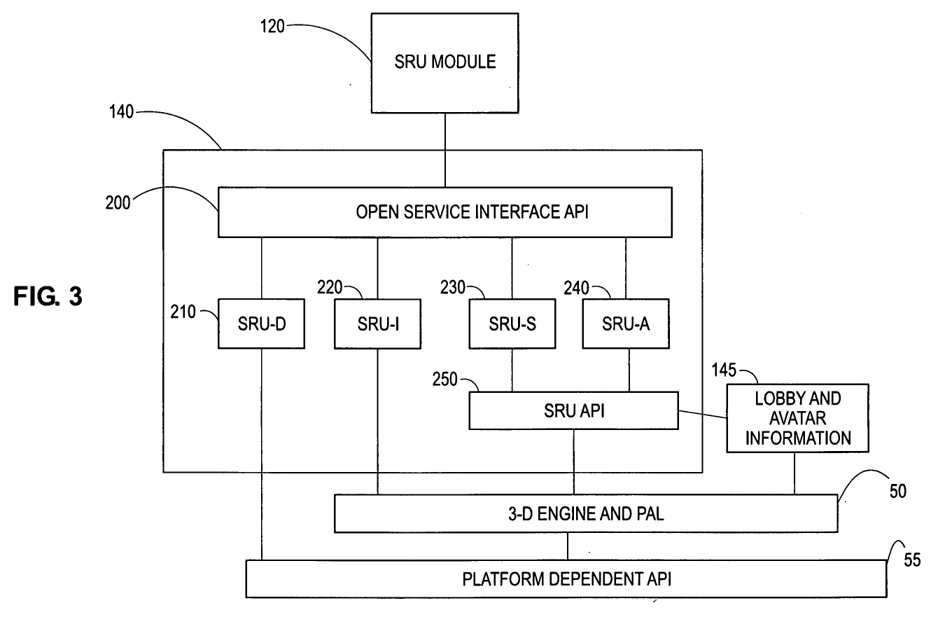

Turning to FIG. 3, an implementation of an SRU manager 140 is shown. The SRU manager may include an open service interface application program interface (“API”) 200 used by the SRU module 120 to access one or more SRUs, 210/220/230/240. An SRU is a general program that executes a particular service and that conforms to the open service interface API 200. As mentioned above, an SRU may be an online service, such as a travel reservation system, an online shopping center, or a game, such as a card game, sports game, or a first person shooting game, such as an MMOG.

Further, an SRU may be developed in a flexible environment, meaning the only requirement is that the SRU support an open service interface API 200. For example, the SRU may be developed using a platform dependent software development kit (“SDK”) or API 55, such as Microsoft's SDK, which is generally dependent on Microsoft's platforms, e.g., Windows. Such SRU's may be referred to as “SRU” direct, or “SRU-D” 210, which directly interface with the platform dependent API 55.

Alternatively, or in addition, as can be appreciated by one of ordinary skill in the art, the SRU may be developed utilizing a platform independent virtual machine 50 included in the client software system 70. The virtual machine 50 may include a three-dimensional engine for the lobby 10 and a platform abstract layer (“PAL”), which provides a wide variety of functionality useful to developing an SRU. For example, the virtual machine may provide online communication capabilities or graphical objects for an SRU. SRU's that utilize the virtual machine 50 may be referred to as “SRU-I” 220, which indirectly interface with the platform API 55.

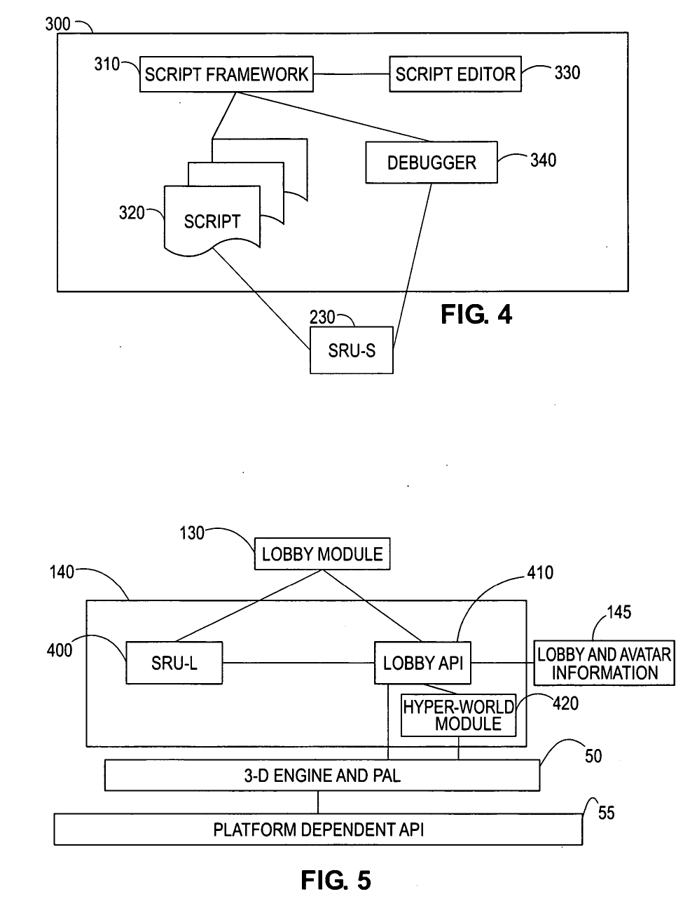

In addition, an SRU may be a service structure for sub-services that may be developed using a pre-established script. Such an SRU may be referred to as “SRU-S” 230. For example, an SRU-S can be a generic card game, wherein the rules of a game may be established using a pre-established script. Turning to FIG. 4, an approach for implementing an SRU-S 230 is shown. The SRU-S 230 is a generic structure configured to execute a script 320 developed from an SRU-S SDK 300. A developer is provided with a script editor 330, which feeds into a script framework 310, which generates the script 320. A debugger 340 is preferably included to debug the script. In one example, the SRU-S may be a card game structure, wherein the rules of the card game, such as poker, bridge, or solitaire, are implemented as scripts 320.

Another type of SRU that may be implemented is the SRU-A 240, which provides the engine for the avatar 20. Both the SRU-S 230 and the SRU-A 240 access the Lobby and Avatar information 145 via the SRU API 250, which also provides access to the 3-D engine and PAL 50.

Turning to FIG. 5, an implementation of the lobby manager 150 is shown. The lobby manager 150 includes an SRU-L 400 that provides the engine for the lobby 10 and the avatars 20/30. The SRU-L 400 may be provided access to the lobby and avatar information 145 and the 3-D engine and PAL 50 via the lobby API 410. The lobby manager 150 may also be provided with a hyper-world module 420, which is a subprogram that provides a display when a user wants to change from one lobby 10 to another. For example, if a user wants to change from a lobby 10 representing London to a lobby 10 representing Beijing, the hyper-world module 420 may display an airplane icon, advertisements, and/or announcements during the transition. As can be appreciated by one of ordinary skill in the art, the lobby manager 150 and its various subcomponents can be implemented using third party three dimensional programming tools known in the art, such as DirectX from Microsoft, and the generated lobby module 130 can be in the form of a three-dimensional DirectX object. The hyper-world module 420 can be a banner program known in the art.

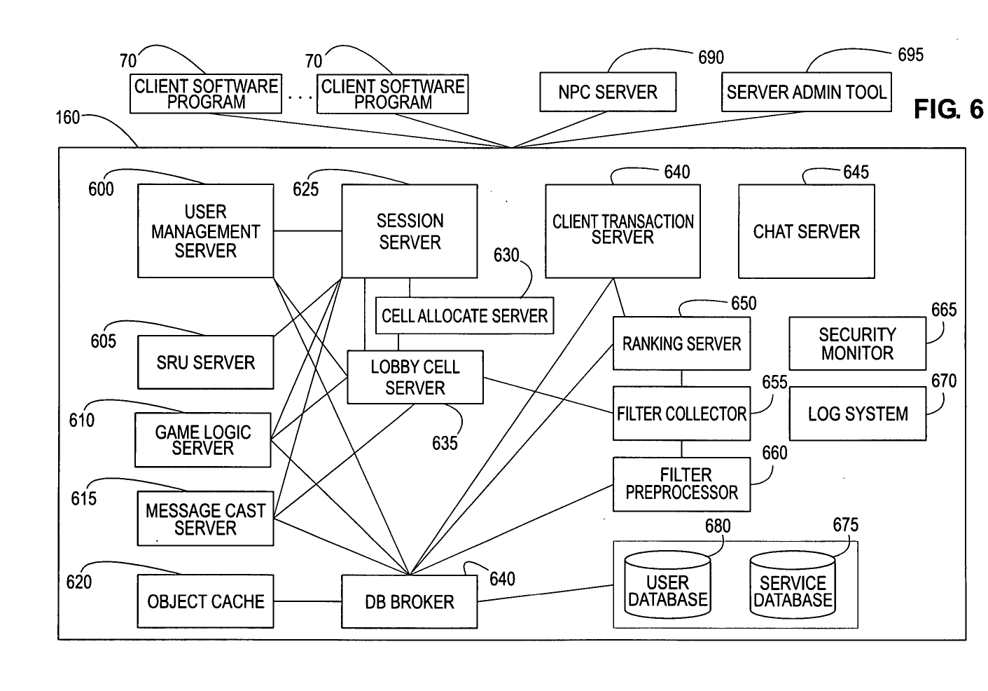

Turning to FIG. 6, an exemplary server 160 is described. The server 160 can be implemented on one or more physical scaleable server machines, such as a Microsoft NT server or a Unix server, using any programming tool known in the art, preferably an object-oriented programming tool. The server component 160, as described above, is accessible by one or more users over a network, such as a global computer network, e.g., the Internet, via a client software program 70, such as described above, that communicates with various components of the server 160 via a client/server API 115. This API may include a network transport layer that interfaces with a network protocol, such as TCP/IP, the protocol commonly used over the Internet. The server 160 includes a session server 625 component, which maintains a direct and persistent network connection between the client software program 70 and the server 160. The session server 625 includes network management components, which are known in the art. Many of the other components that will be described below exchange data with a client software program 70 via the session server 625 component. The session server 625 maintains a list of the users actively participating on the system 100 and a list of the avatars or characters of the active users with the avatars' profiles.

The server 160 further includes a user management server 600, which is a server component that caches users' properties or profile from database 680, such as gender, skill, and gained equipment. Whenever a new user logs in, the new user's profile is cached. Further, the user management server 600 also stores the initial position of a logged in user within the virtual world to be used by the lobby cell server 635, which will be described in more detail below. The user management server 600 may also include a default user position that a user can be restored to if a connection has been dropped or lost.

The server 160 also includes one or more lobby cell servers 635, which maintain the location of the users' avatars within the virtual world established by the system 100. The virtual world is defined by “tiles,” which are basic construction units that define the lobbies within the virtual world, and a single tile may have the size of area that a user can see from the video screen. The lobby cell servers 635 maintain a map of the virtual world defined by tiles, and the location of the avatar of a user actively participating on the system 100 is defined by the tile within the virtual world in which the user's avatar is logically located. This information is queried and updated by the client software 70, preferably through a non-persistent connection. The information is also queried and updated by the session server 625 preferably via a persistent connection, as can be appreciated by one of ordinary skill in the art. The lobby cell servers 635 also maintain the events that occur within a particular tile of the virtual world. For example, if an avatar changes location or position within a tile in response to a user input such as mouse movement, other avatars within viewing scope, e.g., within the same tile, are notified of the changes and the client software programs 70 of the other avatars are updated with the changes. The session server 625 receives the changes from the client software programs 70 of the avatars making the changes and dispatches the changes to the lobby cell server 635 and other components that will be described below. The lobby cell server 635 processes these changes, e.g., calculates distance of change and determines who should be updated with the change, and dispatches the processed changes to the user management server 600, the session server 625, and the corresponding client software programs 70 via the session server 625 and other components as will be described below, such as the message cast server 615. A persistent connection is maintained between the session server 625 and all available lobby servers 635 so that an avatar event, such as position, appearance, or action, can be passed to the proper lobby cell server 635 according to the avatar's location within the virtual world of the system 100. After all of these updates, the client software program 70 of the user triggering the event can confirm the event, such as movement. Preferably, one or two replicas of the lobby cell server 635 are maintained within the system 100 for fault tolerance purposes.

The server 160 can include a plurality of lobby cell servers 635 to maintain a large load of client data. In such a case, the server 160 can further include a cell allocate server 630, which monitors and manages how the load is distributed amongst the plurality of lobby cell servers 635, whereby each lobby cell server 635 maintains the events within a number of tiles. One of ordinary skill in the art would appreciate that some tiles can be more popular than others and would have involve more avatars and more activity/events than other tiles. Such tiles may require larger processing power. The lobby cell servers 635 handling those tiles may have less tiles assigned for management than other lobby cell servers 635 by the cell allocate server 630. The assignments are dispatched by the cell allocate server 630 to the lobby cell server 635 and the session server 625.

The server 160 further includes one or more SRU servers 605, which are a variation of the lobby cell server 635, but services the SRUs instead of the lobby. There are at least two types of SRU servers 605 specifically for online gaming. There is an FPS SRU server 605 dedicated to first person shooting (“FPS”) games, which can be developed using third party three-dimensional programming tools known in the art. An FPS SRU server 605 can provide peer-to-peer (“P2P”) connectivity between a plurality of users. The topology includes multiple hosts. Traditional systems include the use of only one host for P2P topology for its simplicity; however, such an architecture can create a performance bottleneck and a single point of failure. The current topology having multiple hosts addresses these issues and provides for a scaleable system that supports a large number of users. Also, multiple hosts can enhance the overall performance using a transport control protocol (“TCP”) hot line solution known in the art, such as internet service provider (“ISP”) peering, where the internet high-speed broadband service is not fully covered. A simple FPS game can be implemented on an SRU server 605 located on a client machine, remote from the server 160. In other words, a user of the system 100 can develop and establish an FPS game within the system 100 on his/her own client machine.

There is also a geomatrix SRU server 605, which is designed for online games with large maps, e.g., MMOG games, as can be appreciated by one of ordinary skill in the art. The geomatrix SRU server 605 includes features such as frame sync and will also include logic for controlling the corresponding MMOG. A persistent and P2P connection is preferably maintained between a client program 70 and an SRU server 605 when a user is engaging in an SRU service, as described above. A user may initiate a connection with an SRU server 605 via the session server 625. The user's client software program's 70 SRU manager 140 communicates directly with an SRU server 605 via the client/server API 115 for SRU modules 120 that require the exchange of online data with the server and/or other users. One or more replicas of the SRU server 605 are maintained for fault tolerance purposes.

The server 160 also includes a game logic server 610. There are some services and games that require logic, rules, or content that reside on the server 160. Reasons for online storage of the logic, rules, and content include security and management of online game tournaments. The game logic server 610 may further include a scheduling program that schedules dynamic executions of particular games at particular times. The game logic server 610 is implemented to support a scripting language known in the art, such as Lua or Python, to define the logic, rules, and content.

The server 160 further includes a message cast server 615 that broadcasts global, group, or private messages from the components of the server 160 to the client software program 70, such message casting programs are known in the art.

The server 160 further includes a filter collector 655, which calculates a filter list for each avatar based on the avatar's profile and feedback from other users. The results of the calculation is provided to the lobby cell server 635, which forwards the calculations to the relevant client software programs 70 to notify the relevant software programs 70 to apply a filter to the computer screen. A filter preprocessor 660 may be utilized to cache data common to the different filter calculations to increase the speed of the calculations. A ranking server 650 can also be used by the filter collector 655 in its calculations, wherein the ranking server 650 provides ranking information for a particular avatar based on the corresponding user's conduct and activity within the system 100, performance with games played, and other users' feedback of the particular avatar.

For transaction based services provided by the portal, a client transaction server 640 is included in the server 160 for maintaining transactions such as monetary purchases. The client transaction server 640 can be implemented utilizing account management programs known in the art. User specific data, such as avatar profile and client transactions, and service specific data, such as services available, are each stored in a respective database 680 and 675 within the server 160. A database management system or database broker 640 is included in the server 160 to manage the database 675/680 and access to the database 675/680 by the various components within the server 160. Preferably, the server 160 also includes an object cache 620 coupled to the database broker 640, which stores commonly accessed data objects in memory for fast access. The various components described within the server 160 utilizes a network abstract layer (“NAL”), which provides uniform to access other server components.

Other components included in the server 160 include a security monitor 665, which monitors activity within the server 160 by the client software programs 70 for unauthorized activity; a log system 670, which logs user activity in a file and/or database; and a chat server 645, which provides real-time chat sessions between users for the chat modules 111 in the client software programs 70. Other servers that may be used in the portal system include a server administration tool 695 and a non-playing character (“NPC”) server 690. The NPC server 690 simulates and triggers all computer operated characters and avatars in the virtual world, for example, pets or game guide in the street.

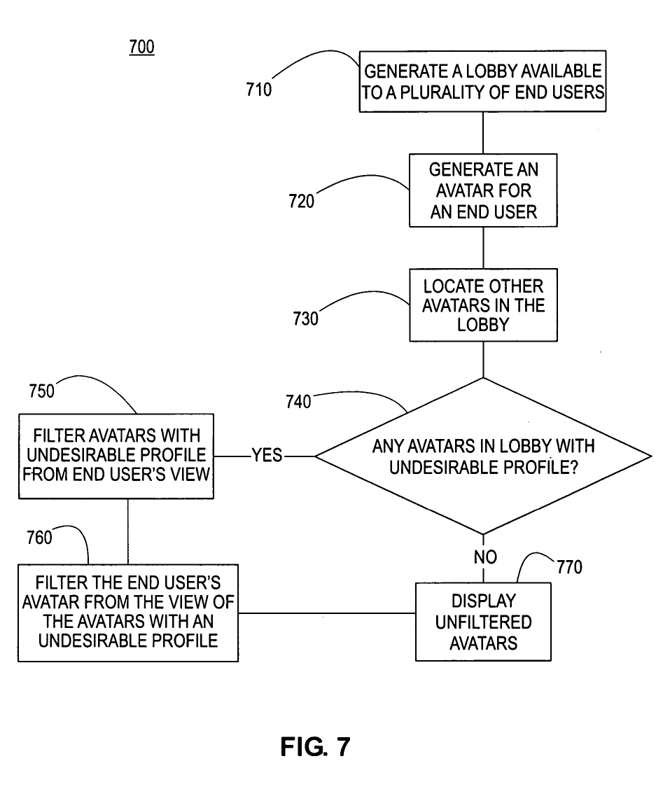

Turning to FIG. 7, a process for filtering undesirable users from view, which can be implemented in the lobby cell server 655, is shown. During operation of the portal, a lobby is generated that is available to a plurality of end users (action block 710). An avatar is generated for each participating end user (action block 720). For a particular user in a particular lobby, the server 160 locates all the other avatars within the lobby (action block 740) and determine whether any of the other avatars have undesirable profiles, such as negative feedback, or if the other avatars have been specifically identified by the particular user as an undesirable avatar (decision block 740). If so, the portal will filter the undesirable avatars from the particular user's view (action block 750) and filter the particular user's avatar from the view of the undesirable avatars (action block 760). The portal will then display the unfiltered avatars to the particular user (action block 770). Thus, the filtering technology is mutual, i.e., it requires that both avatars be unfiltered from each other in order for the avatars, and their corresponding users, to be able to view each other, particularly if they are located in the same tile.

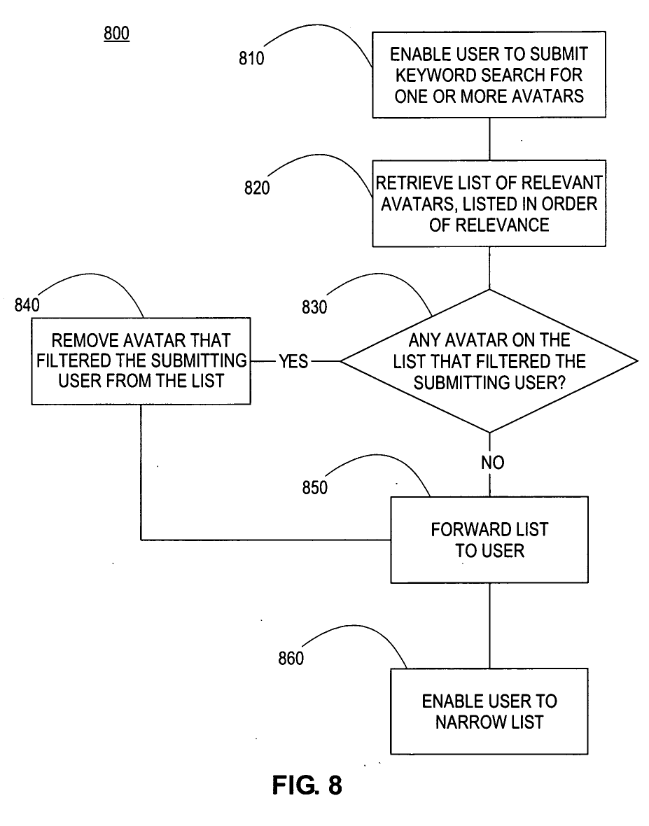

In addition, the server 160 may further include a search engine for searching for other avatars, which may be implemented in the lobby cell server 655. The process 800 of the search engine is shown in FIG. 8. A user is enabled to search for an avatar or a group of avatars by a keyword search that is compared with the avatars' profiles (action block 810). The server 160 then searches all of the avatars' profiles and retrieves a list of the relevant avatars, i.e., avatars with profiles that include the keywords or include information close to the keywords, as would be appreciated by one of ordinary skill in the art (action block 820). Preferably, the list is sorted by order of relevance. The list is then searched for avatars that have filtered the submitting user from view (decision block 830). If there are avatars that have filtered the submitting user from view, then those avatars are removed from the list (action block 840). The finalized list is then forwarded to the submitting user (action block 850). A relevance score may be associated with each avatar within the list. The user may then narrow the list if it is too large for review (action block 860).

Because the portal is a virtual world, the searched avatars should not be relocated within the submitting user's viewing scope if the searched avatars are not currently within the viewing scope. Therefore, the search process 800 may be performed only when the searched avatar is approaching the submitting user's viewing scope. Thus, the search process 800 may provide delayed results, simulating real world behavior.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention can be performed using different or additional process actions, or a different combination or ordering of process actions. For example, the embodiments described above include a client software installed on a user's computer for interaction with the user; however, instead of, or in addition to, the use of client software installed on the user's computer, the user interface may be browser based, wherein the server 160 may be implemented as a web server or coupled to a web server. As a further example, each feature of one embodiment can be mixed and matched with other features shown in other embodiments. Additionally and obviously, features may be added or subtracted as desired. Accordingly, the invention is not to be restricted except in light of the attached claims and their equivalents.

What is claimed is:

1. An online portal having a plurality of end users accessible by a client software to be installed on an end user's workstation, said client software comprising:
a service framework configured to generate and display a three-dimensional graphical lobby accessible by the plurality of end users and a plurality of graphical avatars located within the lobby, wherein each avatar is controlled by at least one of the plurality of end users, wherein an end user is capable of viewing graphical avatars controlled by other end users, and further wherein the end user is capable of mutually filtering one or more of the graphical avatars controlled by the other end users;
a service rendering unit module configured to provide a plurality of independent services to the service framework available for selection by the plurality of end users; and
a lobby module configured to provide lobby and avatar data to the service framework and configured to display the one or more independent services available for selection by the plurality of end users.

2. The client software of claim 1, wherein the one or more services are computer games.

3. The client software of claim 2, wherein the computer games include a massive multi-player online game.

4. The client software of claim 1, further comprising a service rendering unit manager configured to manage the one or more service rendering units and to provide data from the one or more service rendering units to the service rendering unit module.

5. The client software of claim 1, wherein the end user's workstation includes a platform, and the one or more service rendering units include a service rendering unit that directly interfaces with the platform of the end user's workstation.

6. The client software of claim 1, wherein the one or more service rendering units includes a service rendering unit configured to execute one or more scripts that establish a set of rules for the operation of the service rendering unit.

7. The client software of claim 1, further comprising a lobby manager configured to provide lobby and avatar data to the lobby module.

8. The client software of claim 1, further comprising a chat module.

9. The client software of claim 1, further comprising a keyword search module that enables a user to search for other avatars by one or more keywords.

10. A method for providing an online portal to a plurality of end users:
generating a plurality of three-dimensional graphical lobbies accessible by the plurality of end users;
generating an avatar for each of the plurality of end users to control within the graphical lobbies, wherein the plurality of end users are enabled to view each other's avatars;
enabling each end user to mutually filter the avatars of one or more of the plurality of end users; and
providing a plurality of independent services accessible by the plurality of end users within the graphical lobby.

11. The method of claim 10, further comprising filtering avatars from view of an end user that desires to filter said avatars.

12. The method of claim 11, further comprising filtering the end user's avatar from view of the filtered avatars.

13. The method of claim 10, wherein each avatar includes a profile, the method further comprising enabling a user to perform a keyword search on the avatar profiles.

14. The method of claim 13, wherein the keyword search generates a list of profiles relevant to the keyword search, the method further comprising the step of removing one or more profiles associated with avatars that have filtered the user from the list.

15. The method of claim 10, wherein the plurality of independent services includes at least one of a card game, a first person shooting game, or an online retail store.

16. The method of claim 10, wherein at least one of the independent services is available in only one of the plurality of graphical lobbies.

17. The method of claim 10, further comprising providing a chat module for each end user that enables an end user to engage in a chat session with one or more other end users.

18. An online portal accessible to a plurality of end users across a wide area network, comprising:
a server configured to generate a plurality of three-dimensional graphical lobbies, to generate an avatar for each of the plurality of end users to control within the graphical lobbies, and to provide a plurality of independent services accessible by the plurality of end users within the graphical lobby; and
a client software program associated with each end user, communicatively coupled to the server across the wide area network, and configured to access the avatar, the plurality of three-dimensional graphical lobbies, and the plurality of independent services.

19. The online portal of claim 18, wherein the server further includes a filter module configured to filter avatars from view of an end user that desires to filter said avatars.

20. The online portal of claim 19, wherein the filter module is further configured to filter the end user's avatar from view of the filtered avatars.

21. The online portal of claim 18, wherein each avatar includes a profile, the server further comprising a search engine configured to enable a user to perform a keyword search on the avatar profiles.

22. The online portal of claim 21, wherein the search engine is configured to generate a list of profiles relevant to the keyword search, and wherein the server is further configured to remove one or more profiles associated with avatars that have filtered the user from the list.

23. The online portal of claim 18, wherein the plurality of independent services includes at least one of a card game, a first person shooting game, or an online retail store.

24. The online portal of claim 18, wherein at least one of the independent services is available in only one of the plurality of graphical lobbies.

25. The online portal of claim 18, further comprising a chat module for each end user that enables an end user to engage in a chat session with one or more other end users.
